(19) United States
(12) Patent Application Publication
(10) Pub. No.: US 2006/0291983 A1
(43) Pub. Date: Dec. 28, 2006

(54) Apparatus for transporting freight

(76) Inventors: Bernhard Konig, Bobingen (DE); Jurgen Guckenberger, Ochsenfurt (DE)

Correspondence Address: BACHMAN & LAPOINTE, P.C., 900 CHAPEL STREET, SUITE 1201, NEW HAVEN, CT, 06510, US

(21) Appl. No.: 11/475,402

(22) Filed: Jun. 26, 2006

(30) Foreign Application Priority Data
Jun. 27, 2005 (DE) 10 2005030058.8-2

(51) Int. Cl. B65G 13/00

(52) U.S. Cl. 414/391; 193/35 SS; 198/780

(57) ABSTRACT

In an apparatus for transporting freight, in particular freight containers in freight compartments of airplanes, in particular a power drive unit (PDU) having a transporting roller (2), which is inserted into a frame, is driven by a drive and can be moved out of the frame by a lifting drive (10), the drive (9) for driving the transporting roller (2) and the lifting drive (10) for moving the transporting roller (2) out of the frame should be arranged within a common motor housing (6).

### BACKGROUND OF THE INVENTION

The present invention relates to an apparatus for transporting freight, in particular freight containers in freight compartments of airplanes, in particular a power drive unit (PDU) having a transporting roller, which is inserted into a frame, is driven by means of a drive and can be moved out of the frame by means of a lifting drive.

Such apparatuses for transporting freight are generally referred to as power drive units (PDUs) and are used in particular for actively and/or passively transporting freight containers in freight compartments of airplanes.

Such apparatuses, in particular power drive units, are subject to particularly stringent requirements in the aviation sector since they need to accommodate very high loads, function in a very reliable manner and should only have a low weight.

In addition, it should be possible for these apparatuses to be replaced very quickly owing to short maintenance times if they need to be overhauled, for example, or if they are defective.

Weight reduction plays an ever greater role in aviation, with the result that, even in the case of small units such as PDUs, the overall weight needs to be reduced.

It is therefore the object of the present invention to provide an apparatus of the type mentioned initially which eliminates the mentioned disadvantages and with which it is possible to realize a space-saving, weight-saving and compact design in a rapid and simple, cost-effective manner.

In addition, it should be possible to extend maintenance intervals and to replace individual components of a PDU quickly, and the electronics should be free from waste heat originating from the drives.

### SUMMARY OF THE INVENTION

The foregoing object is achieved by providing an apparatus for transporting freight, in particular freight containers in freight compartments of airplanes, in particular a power drive unit (PDU) having a transporting roller, which is inserted into a frame, is driven by means of a drive and can be moved out of the frame by means of a lifting drive, characterized in that the drive for driving the transporting roller and the lifting drive for moving the transporting roller out of the frame are arranged within a common motor housing. The object is further achieved by providing an apparatus for transporting freight, in particular freight containers in freight compartments of airplanes, in particular a power drive unit (PDU) having a transporting roller, which is inserted in a frame, is driven by means of a drive and can be moved out of the frame by means of a lifting drive, characterized in that the drive for driving the transporting roller and the lifting drive are inserted in an integrated manner in a common motor housing and can be controlled independently of one another.

With the present invention it has proven to be particularly advantageous to insert a drive for the at least one transporting roller and a lifting drive for driving the at least one cam together into a common motor housing, it being possible to control, regulate and actuate the drive and the lifting drive separately from one another.

A controller having a housing adjoins the common motor housing, at a distance and separately, with the result that no waste heat from the motor housing impairs the electronic control.

In addition, one advantage of the present invention is the fact that, approximately at the front end, two frame structures adjoin the motor housing on both sides and connect the apparatus, in each case at the front end, output drives of the drive and the lifting drive protrude out of the motor housing, in particular out of a sleeve inserted there, in order to drive the transporting roller or the cam or the camshaft directly or indirectly via corresponding diverter elements, gears or the like.

It is advantageous in this case that the motor housing can be removed from the two frame structures very rapidly and cost-effectively for the purpose of replacing the drive and/or the lifting drive, and a corresponding, overhauled or new motor housing with new or overhauled drives or lifting drives can be inserted again.

It is also advantageous that, owing to a compact design of the drive and the lifting drive with motor shafts lying on one axis and a common central bearing block, this unit as a result has a low overall weight while maintaining a high degree of stability of the frame structures of the apparatus or the PDU.

Owing to such a compact design, it is also possible for transporting rollers having relatively large diameters to be inserted and used. This is also the case for a tandem operation, with the result that, for example, two transporting rollers can be inserted between the frame structures.

In addition, one advantage of the present invention is the fact that the drive and the lifting drive can be controlled in a common electrical controller, in which case waste heat from the drive and the lifting drive does not impair the control.

Owing to the compact design of the drive and the lifting drive in a common sleeve or in a common motor housing one behind the other, it is not only possible to reduce the overall weight of the apparatus but it is also possible, in addition, to realize a very space-saving refinement of the apparatus.

### BRIEF DESCRIPTION OF THE DRAWINGS

Further advantages, features and details of the invention are described in a preferred exemplary embodiment and with reference to the drawings, in which

FIG. 1 shows a schematic, perspective view of an apparatus for transporting freight;

FIG. 2 shows a schematic view from below of the apparatus for transporting freight as shown in FIG. 1;

FIG. 3 shows a schematic plan view of a component of the apparatus for transporting freight;

FIG. 4 shows a schematic, perspective view of the component shown in FIG. 3; and

FIG. 5 shows a longitudinal section through the component shown in FIG. 3, in a schematic illustration.

### DETAILED DESCRIPTION

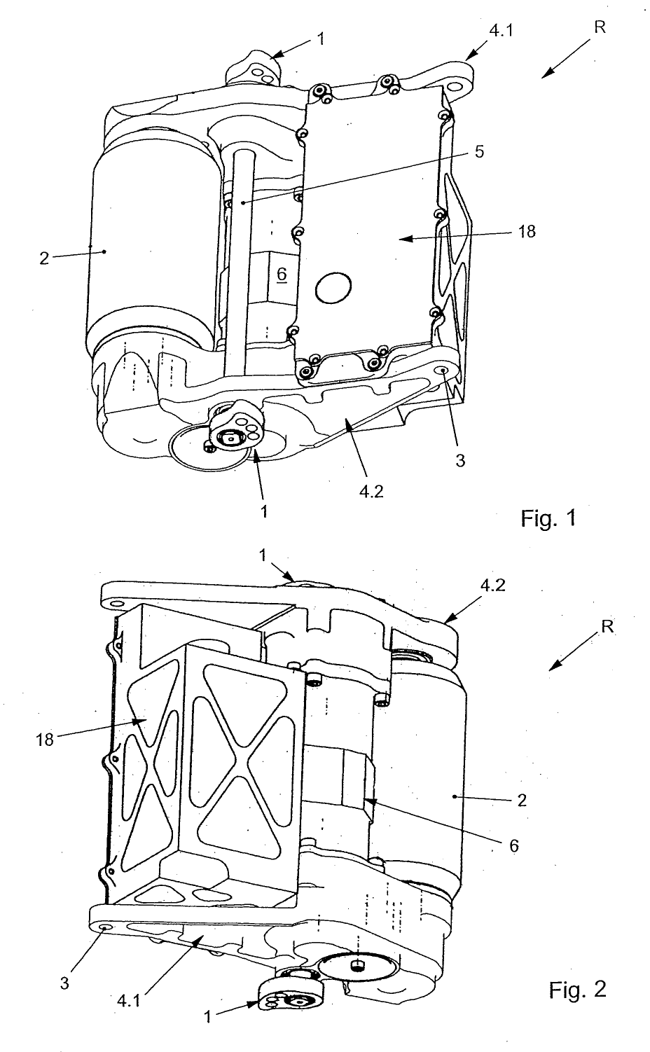

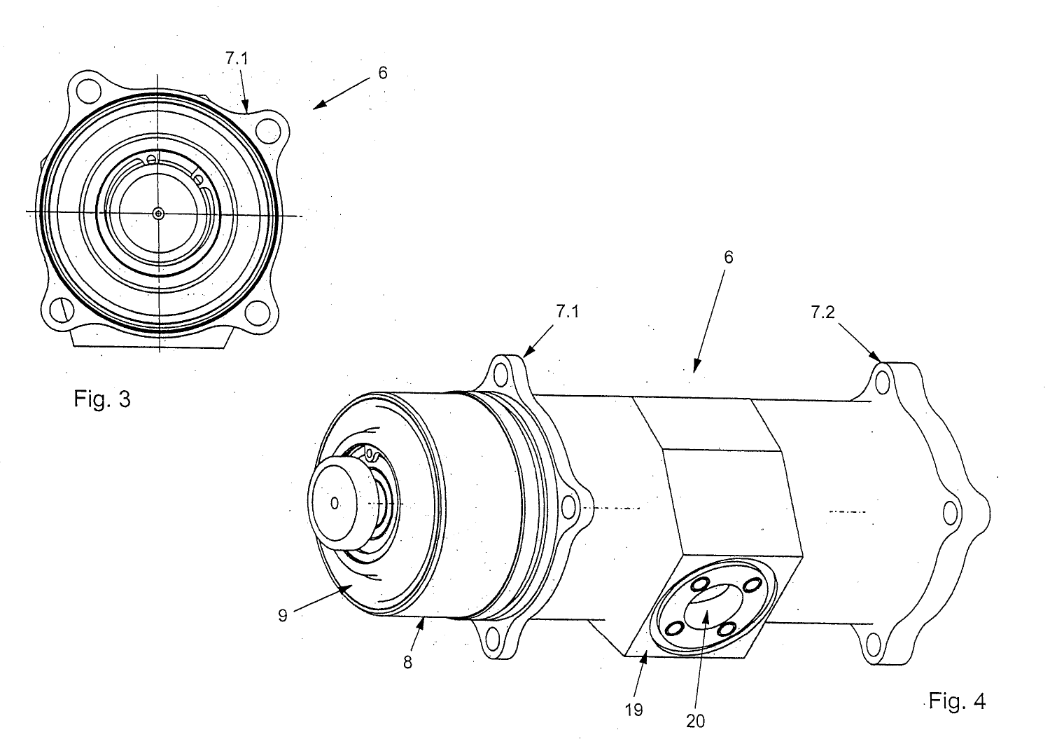

As shown in FIG. 1, an apparatus R according to the invention for transporting freight, in particular freight containers in freight compartments, essentially referred to as a power drive unit (PDU), has a frame (not illustrated in any more detail here), with respect to which the PDU can be pivoted or moved out of a main frame, basic frame, frame structure or the like via corresponding cams 1 in order to pivot a transporting roller 2 out about a hinge 3 of a frame structure 4.1, 4.2.

In this case, the cams 1, which are pivoted via a common camshaft 5, in each case protrude laterally out of the frame structures 4.1, 4.2.

The transporting roller 2 is used for lifting the freight; it can be set in a drive-free manner, however it is preferably actively driven for the purpose of moving, in particular driving the freight.

The transporting roller 2 is mounted in a rotary fashion and such that it can be driven between the two frame structures 4.1, 4.2, corresponding gears, diverter gears or the like (not illustrated in any more detail here) being integrated in the frame structure 4.1 and/or 4.2.

It has proven to be particularly advantageous in the present invention that a preferably supporting motor housing 6 is arranged between the two frame structures 4.1, 4.2, between which the transporting roller 2 is also inserted.

In this case, the motor housing 6 has corresponding fixing flanges 7.1, 7.2 which are fixedly adjoined by the respective lateral frame structures 4.1, 4.2 of the apparatus R.

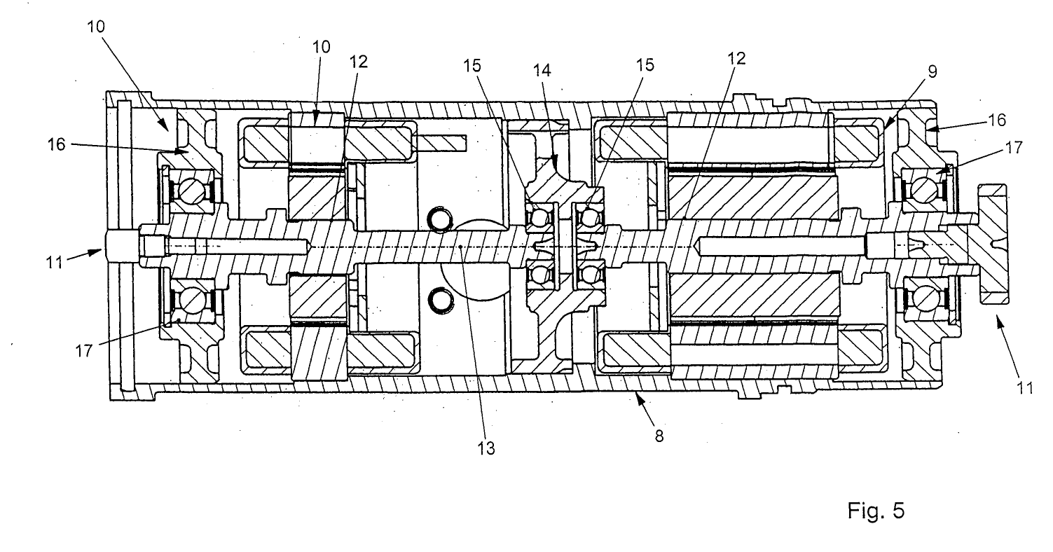

A sleeve 8 is inserted in a detachable manner into the motor housing 6, as can be seen from FIGS. 4 and 5, and is used for accommodating a drive 9 and a lifting drive 10.

In this case, at the front end, in each case output drives 11 of the drive 9 and the lifting drive 10 protrude out of the sleeve 8 and drive, on the one hand, the transporting roller 2 and, on the other hand, the at least one cam 1 or the camshaft 5 via corresponding toothed belts, toothed wheels, gears or the like, which are inserted in the structure 4.1, 4.2.

One particular feature of the present invention consists in the fact that the drive 9 for driving the transporting roller and the lifting drive 10 for driving the camshaft 5 or the cam 1 are arranged and inserted in an integrated manner in a common motor housing 6 as an individual unit, in particular in a common sleeve 8.

In this case, the drive 9 and the lifting drive 10 are inserted into the sleeve 8 one behind the other in a row, in each case such that they can be controlled and driven individually.

In this case, it has also proved to be advantageous that the respective motor shafts 12 of the drive 9 and the lifting drive 10 lie in a common axis 13 and, in order to reduce the weight of the unit, in particular of the drive 9 and the lifting drive 10, the two motor shafts 12 are mounted in a common bearing block 14, which can be inserted approximately centrally in the sleeve 8, via corresponding bearing elements 15, in each case separately from one another.

At the front end or in the end-side region, further bearing blocks 16 are inserted into the sleeve 8 and bear the motor shafts 12 at the other end via bearing elements 17. The drive 9 and the lifting drive 10 are fitted with stator and rotor elements (which are not provided with any further reference symbols here) between the bearing elements 17 and 15.

The advantage of accommodating the drive 9 and the lifting drive 10 in a common motor housing 6 or in a common sleeve 8 is firstly that only one common controller 18 can adjoin an accommodating flange 19 with a bushing 20 in order to control or regulate the drive 9 or the lifting drive 10 in each case individually and independently.

In addition, the drive 9 and the lifting drive 10 share a common bearing block 14, which likewise serves the purpose of reducing the weight.

One further advantage of the present invention is the fact that the drive 9 and the lifting drive 10 can be replaced very rapidly, as a common unit, merely by disassembling the sleeve 8 or the motor housing 6 should they require any maintenance or need to be replaced.

In addition, it has proven to be particularly advantageous that, owing to such a compact design and owing to the arrangement of the drive 9 and the lifting drive 10 in the sleeve 8 in a row 1, it is possible to use and install a transporting roller 2 which has a larger cross section.

1. Apparatus for transporting freight, in particular freight containers in freight compartments of airplanes, comprising a power drive unit (PDU) having a transporting roller (2) which is inserted into a frame, said roller is driven by a drive (9) and is selectivey moved out of the frame by means of a lifting drive (10), wherein the drive (9) for driving the transporting roller (2) and the lifting drive (10) for moving the transporting roller (2) out of the frame is arranged within a common motor housing (6).

2. Apparatus for transporting freight, in particular freight containers in freight compartments of airplanes, comprising a power drive unit (PDU) having a transporting roller (2), which is inserted in a frame, said roller is driven by a drive (9) and is selectively moved out of the frame by a lifting drive, wherein the drive (9) for driving the transporting roller (2) and the lifting drive (10) is inserted in an integrated manner in a motor housing (6) and can be controlled independently of one another.

3. Apparatus according to claim 1 or 2, wherein motor shafts (12) of the drive (9) and of the lifting drive (10) are on a common axis (13) in the motor housing (6).

4. Apparatus according to claim 3, wherein the two motor shafts (12) of the drive (9) and the lifting drive (10) are each kept mounted separately, centrally in a common bearing block (14).

5. Apparatus according to claims 3, wherein the drive (9) of the transporting roller (2) and the lifting drive (10) are inserted in an integrated manner in a common sleeve (8) which is removably inserted into the motor housing (6) in a replaceable manner.

6. Apparatus according to claim 3, wherein the motor housing (6) has lateral fixing flanges (7.1, 7.2) which are adjoined laterally by diverter elements and gear elements.

7. Apparatus according to claim 5, wherein the sleeve (8) is inserted in a detachable and replaceable manner between two frame structures (4.1, 4.2), the transporting roller (2) being inserted between the frame structures (4.1, 4.2).

8. Apparatus according to claim 3, wherein the lifting drive (10) drives a common camshaft (5) in a rotary fashion for the purpose of driving at least one cam (1) protruding out of a lateral frame structures (4.1, 4.2).

9. Apparatus according to claim 5, wherein the lifting drive (10) and the drive (9) are formed from a stator and a rotor within the sleeve (8), lying on one axis (13), wherein the lifting drive (10) and the drive (9) for driving the transporting roller (2) are controlled and driven separately.

10. Apparatus according to claim 5, wherein an output drive (11) of the lifting drive (10) for driving at least one cam (1) protrudes out of the sleeve (8) at one end and, at the other end, a further output drive (11) of the drive (9) for driving the transporting roller (2) protrudes out of the sleeve.

11. Apparatus according to claim 5, wherein the motor housing (6) for accommodating the sleeve (8) has an accommodating flange (19) for accommodating a controller (18) and a regulator for the lifting drive (10) and the drive (9) for the transporting roller (2).

12. Apparatus according to claim 11, wherein the motor housing (8) has at least one bushing (20) in the region of the accommodating flange (13) for control purposes and for the purpose of passing through a cable.

13. Apparatus according to claim 3, wherein the lifting drive (10) and the drive (9) are arranged as one unit centrally between the transporting roller (2) and a controller (18).
